(19) United States
(12) Patent Application Publication
(10) Pub. No.: US 2003/0046403 A1
(43) Pub. Date: Mar. 6, 2003

(54) Method for routing data streams of a communication connection between users of a connectionless packet data network, and a packet data network, a control device and a program module therefore

(75) Inventor: Hartmut Schmidt, Grossbottwar (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/200,500

(22) Filed: Jul. 23, 2002

(30) Foreign Application Priority Data
Jul. 30, 2001 (EP) 01 440 242.4

(51) Int. Cl. G06F 15/16

(52) U.S. Cl. 709/228; 709/231

(57) ABSTRACT

The invention concerns a method for routing data streams between users of a connectionless packet data network, a call signalling being performed, between a calling user, a control device and a called user, in the course of which the calling user sends to the control device a request for a communication session with the called user and this control device ascertains a network address of the called user, the control device defining one or more network nodes via which the data packets to be sent in connection with the communication session between the users, in a respectively determined sequence for each transmission direction, are to be routed, and the control device sending to the users and to the defined network node(s) participating in the communication session address information respectively required for relaying or forwarding the data packets in the defined sequence, and a packet data network, control device and program module for the same.

### BACKGROUND OF THE INVENTION

The invention is based on a priority application EP 01 440 242.4 which is hereby incorporated by reference. The invention concerns a method for routing data streams or a sequence of data packets between users of a connectionless packet data network, and a packet data network with means for routing data streams between the users, a control device and a program module therefore.

Conventional connection-oriented telephone networks, for example, the public switched telephone network (PSTN) or the digital cellular GSM mobile telephony network (GSM: global system for mobile communication), in order to establish a connection, i.e., a payload channel between a calling and a called user, execute a signalling protocol in which a network-side check is first performed to determine whether the called user is known and whether this user can be accessed. If the result is positive, the desired connection is then established by means of selected switching centres in the telephone network. Network-side monitoring devices provide for effective control and monitoring of the connections. Thus, each connection is supported with a guaranteed transmission bandwidth; in the case of an imminent overload of individual network lines, alternative network lines can be switched in or further incoming call requests can be rejected. The complete network-side connection monitoring also provides for the legally prescribed facility to tap certain calls. A called user of the telephone network has extensive facilities for monitoring incoming calls or call requests. Thus, he can interrupt an existing call or reject a call request if, upon activation of the calling line identification (CLI), a call number is identified which is unwanted or which is not included in the call numbers associated with the called user. On the other hand, a calling user can maintain his anonymity, either for one call or generally, by preventing the call number being identified by the terminal of the called user.

In a networked connectionless packet data network, the users communicate with one another without the mediation of network devices. No communication channels or connection paths are established. At the network nodes of such a network, so-called routers, each data packet is individually checked in respect of its destination address and then forwarded accordingly. A connection can be secured solely from user to user. The best known network of this type is the so-called internet. On the internet, data packets are addressed through the so-called internet protocol (IP), referred to below as the IP protocol. The internet users do not have direct access to the internet. The internet is accessed by means of access networks at defined access points of the internet. Frequently, the conventional telephone network serves as an access network, via which a connection is established to a so-called (internet) access server. Other known connectionless packet data networks are constituted by so-called intranets which, unlike the internet, constitute closed networks.

Call signalling on the internet can be performed using, for example, the so-called session initiation protocol (SIP) RFC 2543, proposed by the Internet Engineering Task Force (IETF). In this connection, a draft by the Internet Engineering Task Force for safeguarding caller anonymity, entitled “SIP Extensions for Caller Identity and Privacy”, exists as a so-called IETF Internet Draft. This draft describes a development of the session initiation protocol in which it is assured, by means of so-called proxy servers, that no data identifying the caller is forwarded to the called party upon call signalling. It also describes a method in which, by means of a device termed an anonymizer in the draft, the internet addresses of the respective users remain invisible to one another in the case of a data exchange. However, the interaction between this anonymizer and the above-mentioned proxy servers is not described in the said document.

The connection of an intranet to the internet is monitored by defined security nodes. In order to protect the intranet and its users, such a safety node, commonly termed a “firewall”, monitors incoming and outgoing data streams according to defined criteria and prevents the forwarding of unwanted data streams. Unwanted data streams can be, for example, data streams directed into an intranet from certain senders, or those having certain data formats or certain content; in the latter case, the payload data must be checked, for example, for certain keywords. Such a security server, however, is not capable of fundamentally distinguishing between so-called wanted and unwanted data streams. Thus, unsolicited incoming data streams, for example, data streams with advertising content, may be unwanted, while the same data may be wanted if it has been requested. This problem exists particularly in the case of (real-time) data streams for multimedia applications, for example, in the case of speech data for internet telephony (voice over IP), which also require data streams to be monitored dynamically. Thus, for example, an “allowed” data stream between two users immediately becomes a “non-allowed” data stream when one of these users terminates the connection and the resources which are thereby released are assigned elsewhere.

Unlike present-day networks, future communications networks or so-called “next generation networks” (NGN) and also, in particular, future mobile telephony networks according to the so-called UMTS standard (UMTS=universal mobile telephone system) will be realized as pure internet-protocol-based networks, referred to in short below as IP networks, as far as the end customer, i.e., each user can then be addressed directly via his IP address. These networks can, of course, be realized as closed IP networks, i.e., networks which can only be accessed from the outside via defined access devices (gateways) which can control the access. As is common for present-day intranets, these networks can also be realized as networks which each have their own IP address space, i.e., with IP addresses which are uniquely defined only within the respective network.

“Next generation networks” will have a high degree of real-time or multimedia communication. This, however, requires the realization of corresponding control and monitoring mechanisms of existing telephone networks, in particular, the guarantee of defined quality standards, an extensive protection of the users and of the network and, not least, uninterrupted charging of communications services. Such control and monitoring, however, is only permitted in an inadequate manner by existing IP networks.

### SUMMARY OF THE INVENTION

The object of this invention is to create a method and corresponding means in order to realize the control and monitoring mechanisms of existing telephone networks, described above, in a connectionless packet data network for the transmission of real-time data streams.

The fundamental concept of the invention is that, for the purpose of establishing a communication session between users of a connectionless packet data network, a call signalling is first performed, for example, according to the session initiation protocol (SIP) described above. In this connection, the calling user sends a request for a communication session with another, or called, user to a control device. This control device then ascertains the network address of the called user, which is unknown to the calling user. The control device then defines a network node, or a sequence of network nodes, via which the data packets to be exchanged between the users are to be routed.

If, for example, a single network node is defined, the control device sends the network address of this network node to each of the users, in order that the said data packets are sent to this network node. The network node receives the network addresses of the users and an instruction to send data packets of respectively one user of the communication session to the respectively other user with exchange of the network addresses.

### DETAILED DESCRIPTION OF THE INVENTION

Further developments of the invention are disclosed by the sub-claims and the following description.

The invention is explained further in the following with reference to the accompanying drawings, wherein:

FIG. 1 shows a packet data network for executing a method, according to the prior art, for establishing a communication connection,

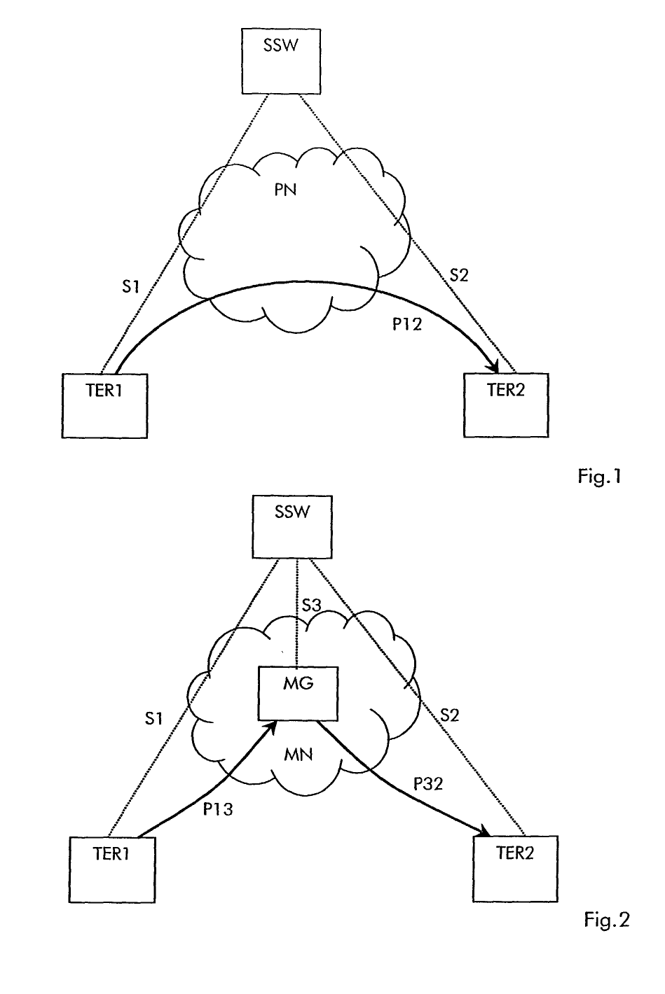

FIG. 2 shows a multimedia network for executing a method, according to the invention, for establishing a communication connection, and

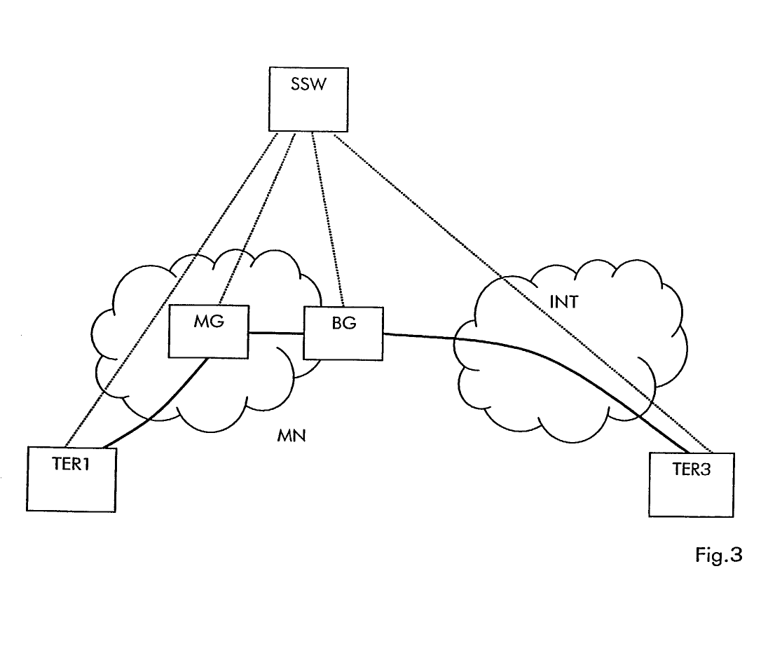

FIG. 3 shows a multimedia network according to FIG. 2 with an interface to the internet.

FIG. 1 shows a packet data network PN for executing a method, according to the prior art, for establishing a (multimedia) communication connection between two users. The figure represents, for this purpose, the packet data network PN, a control device SSW, a first terminal TER1, also referred to in the following as a first user TER1, and a second terminal TER2, also referred to in the following as a second user TER2. Shown between the control device SSW and the first user TER1 and between the control device SSW and the second user TER2 are first and second signalling connections S1 and S2 respectively, represented as broken lines. These signalling connections S1 and S2 each consist of a number of defined signalling packets. A solid-line double arrow represents a data relationship P12 between the first user TER1 and the second user TER2, this data relationship consisting of data streams or sequences of data packets for one or more multimedia applications.

It is to be assumed in the following that, in the packet data network PN, addressing is effected by means of the said internet protocol. For the purpose of establishing a communication connection between the users, a call signalling is performed, for example, the above-mentioned session initiation protocol (SIP) or a call signalling, described by the International Telecommunication Union in connection with the document “Packet-based Multimedia Communications Systems”, ITU-T Recommendation H.323, referred to in short below as the H323 protocol. These protocols each define the above-mentioned signalling packets S1 and S2 and their sequences according to the occurrence of different situations. The following does not detail the structures, contents and sequences of individual signalling packets, but describes only the essential information exchange associated with these signalling packets. The first user TER1 sends to the control device SSW a prompt or request for a communication connection with the second user TER2 and a number or character string which uniquely identifies this user, for example, his call number. The control device SSW, which is also termed a gatekeeper in the context of the H323 protocol and a proxy server in the context of the session initiation protocol (SIP), ascertains the IP address of the second user TER2, for example, by means of an address databank, not represented here, and informs the second user TER2 of the call. If the second user TER2 wishes to accept the call, he communicates to the control device SSW his consent to the call and a UDP address for addressing a defined resource. The control device SSW then sends the IP address and the UDP address of the second user to the first user TER1. The first user TER1 then, without further mediation of the control device SSW, commences transmission of data packets P12, using the obtained addresses of the second user TER2 as the destination address, directly to the second user. The second user TER2 can then obtain the IP address or the UDP address of the first user TER1 directly from the corresponding protocol information of the received data message.

The internet protocol represents the characterizing protocol layer of the protocol sequence of the packet data network PN. This layer represents the so-called network layer of the so-called OSI layer model (OSI=open system interconnection). The network layer serves the purpose of network connection between (end-) users. Whereas, in a line-conducted communications network, for example, the public switched telephone network (PSTN), a physical connection must be established or a line must be switched for the exchange of data between users, in an IP network, unless preventive measures are taken, each user can in principle access each other user without mediating network devices. No connection is established in this case. The data packets are addressed directly from user to user. For this purpose, the sending user enters both his source address and the destination address in the header for each data packet. This header, together with a payload part, also referred to as a payload data packet in this case, represents a so-called (IP-) data message.

For the purpose of addressing one of various applications of a user, the so-called user data protocol (UDP) is used for real-time applications. This protocol represents the so-called transport layer of the protocol sequence of a real-time IP network. Unlike the so-called transmission control protocol (TCP), which is used for data services on the internet, this protocol does not have any connection monitoring. The transmission control protocol has comprehensive monitoring mechanisms for monitoring a correct data transmission, but is unsuitable for real-time applications, particularly due to the provision of a repeated transmission of data packets in the event of an error. The user data protocol serves essentially to address one of various resources of a user, a so-called UDP port, and does not provide any reception and sequence monitoring of data packets.

The so-called real-time transport protocol (RTP) is used for sequence monitoring and for monitoring the time behaviour. This protocol, proposed by the Internet Engineering Task Force (IETF), as RFC 1889, can be considered as belonging to the transport layer described above.

As described above, future communications networks will increasingly be realized as pure IP networks having, to a substantial degree, multimedia applications with real-time requirements. Several problems result from this: multimedia applications require guaranteed bandwidths and guaranteed maximum transmission delays. Unlike line-conducted telephone networks, these requirements cannot easily be met in IP networks in the absence of means of monitoring and controlling the data traffic. Also absent is the facility which exists in line-conducted networks for legally prescribed, undetected tapping of calls (legal interception). Due to the, in principle, free addressing in IP networks it is possible for each user to send data to any other user without monitoring. Not least, comprehensive monitoring for the purpose of averting unwanted data, for example, by means of an above-mentioned firewall, is not possible due to the real-time conditions of multimedia applications. A category of unwanted data in this case concerns unsolicited data packets which are in each case sent multiply, i.e., at short intervals of time, possibly from different sources, to the same user or network device. If such data attacks cannot be averted, they can result in the complete overloading of a network device or of a user, with the consequence that this network device or user can no longer provide a service (denial of service).

Represented schematically in FIG. 2, for the purpose of overcoming the above-mentioned problems, is a packet data network, according to the invention, for multimedia applications, referred to in short below as a multimedia network MN. Unlike the packet data network PN represented in FIG. 1, the multimedia packet data network MN comprises a network node MG (media gateway). Also shown are the control device SSW, the first user TER1 and the second user TER2, which are known from FIG. 1. Shown again between the control device SSW and the first user TER1 and the control device SSW and the second user TER2 are first and second signalling connections S1 and S2 respectively, represented as broken lines. A third signalling connection S3 is additionally shown between the control device SSW and the network node MG. Instead of a data relationship P12 directly between the first user TER1 and the second user TER2, in this case a first data relationship P13 and a second data relationship P23 are respectively shown between the first user TER1 and the network node MG and between the second user TER2 and the network node MG, again represented as solid-line double arrows.

Although the method described with reference to FIG. 1 permits anonymous call signalling, it does not permit anonymous transmission of data. The sender and receiver must each know the address of the other in order to be able to exchange data. Even if it were assumed that IP addresses are assigned only at short notice and for a short period, a user participating in a call could transmit data to the other user until his IP address were withdrawn or became invalid. By contrast, in the case of the method presented here, with a (central) network node MG or a series of corresponding network nodes, there is comprehensive monitoring of all data streams. Moreover, this method offers several advantages:

anonymization of data streams

limitation or exclusion of unmonitored data communication

interfaces for legal interception

capacity control and capacity routing

communication of announcements and

interfaces for convenient charge logging.

For the purpose of establishing a communication connection between the users of the multimedia network MN, a call signalling is performed, as described with reference to FIG. 1, by means of an appropriate signalling protocol, for example, the session initiation protocol (SIP). In the following, the associated information exchange is to be described in terms of function, and irrespective of the protocol selected. For reasons of greater availability (reliability) and better network structuring capability, a larger multimedia network MN is advantageously provided with a series of such network nodes MG. An embodiment example of a method according to the invention is to be described in the following with, for reasons of simplicity, only one participating network node MG:

The first user TER1 sends to the control device SSW a prompt or request for a communication connection with the second user TER2 and a number or character string which uniquely identifies this user, for example, his call number. The control device SSW, which can consist of a central computer or multi-computer system or a spatially distributed decentralized multi-computer system, ascertains the IP address of the second user TER2 and defines a network node MG via which the data traffic is to be routed. The control device SSW informs the second user TER2 of the call from the first user TER1. If the second user TER2 wishes to accept the call, he communicates his consent to the call to the control device SSW. As part of this call signalling, both users TER1 and TER2 also send to the control device SSW the UDP address respectively determined for the addressing of a defined resource. The control device SSW then respectively sends to the first user TER1 and to the second user TER2, via the signalling connections S1 and S2 respectively, the IP address of the network node MG and the corresponding UDP address of this network node MG. This resource of the network node MG corresponds to a defined communication session. The IP address and the UDP address of each user TER1 and TER2 is sent to the network node MG via the third signalling connection S3. The IP address of a user or of a network node and the UDP address of the defined resource thus form, for each communication session, a fixed tuple or fixed assignment which can also be verified in the network node.

The first user TER1 sends data messages of the first data relationship P13 to the network node GW. This network node GW checks the validity of these data messages, i.e., the correct assignment of source and destination information and sends them, with an exchange of the source and destination address, i.e., the corresponding IP addresses and UDP addresses, as data messages of the second data relationship P23, to the second user. The data transmission in the opposite direction is performed analogously. If one of the users signals the end of this communication to the control device SSW, or if the control device determines the end of this communication, it informs the network node MG which then ceases to switch any subsequent data.

The exchange of the IP addresses preserves the anonymity of both users, unless they intentionally communicate their identities. Each user has the possibility of terminating the communication at any time without fear of receiving further unwanted data. In addition, due to the fact that the entire data traffic is monitored and routed via defined network nodes GW which are located inside a trusted boundary of the multimedia network MN, no data attacks of any kind can be carried out.

These network nodes GW can each be provided with a secured interface for the purpose of charge determination and for legal interception. Since the creation of new networks requires large amounts of investment, the tariff metering facilities in existing IP networks are not sufficient. The monitored routing of the data traffic in accordance with the present-day telephone networks also enables corresponding convenient tariff metering (i.e., implementation of different tariff models) and comprehensive charge logging (i.e., exclusion of avoidance opportunities) to be supported. For this purpose, the network nodes GW can relay to a charging device, which is not described further in this document, precise data relating to each communication session, for example, the accumulated connection time and/or the accumulated quantity of transmitted data.

Hitherto, it has been assumed in each case that communication sessions are between two users TER1 and TER2. It is obviously also possible for several users to participate in a communication session. Existing call protocols (SIP, H323) offer possibilities appropriate to call signalling between several users. Each network node MG participating in the communication session is then sent, for each source address concerning it, a list of corresponding destination addresses (further network nodes and/or users). A communication session is identified in the network node MG by means of the UDP address, as previously described. It is thus possible for users to be added to and removed from a communication session without the intervention of the other users; i.e., the data streams are controlled without intervention by the users. The data streams intended for one user from several other users are in this case combined in the network node MG. For this purpose, the corresponding RTP data streams are interrupted in this network node MG and a new RTP data stream is generated.

A communication by a user from a packet data network according to the invention, as shown in FIG. 2, with a user of the internet is to be described with reference to FIG. 3. For this purpose, FIG. 3 shows the multimedia network MN with the network node MG and a control device SSW from FIG. 2. Also shown is a border gateway BG which is connected to the internet INT. A third user TER3 is connected to the internet INT. A solid line in each case connects the first user TER1 to the network node MG, the network node MG to the border gateway BG and the border gateway BG to the third user TER3, via the internet INT. These lines represent a payload data relationship between the first and the third users TER1 and TER3. Broken lines respectively connect the control device SSW to the first user TER1, the network node MG, the border gateway BG and the third user TER3. As in the preceding figures, these broken lines represent signalling connections, each consisting of a number of defined signalling packets.

For the purpose of establishing a communication connection between the first user TER1 of the multimedia network MN and the third user TER3 of the internet INT, one or more appropriate signalling protocols are selected, as described with reference to the preceding figures. In the following, an exemplary protocol sequence is to be described in terms of function. Since, in this case, it is primarily a matter of effectively protecting the multimedia network MN and its users TER1 against unwanted data from outside, a call to the first user TER1 from the third user TER3 is to be described here. The third user TER3 sends to the control device SSW a prompt or request for a communication connection with the first user TER1. The control device SSW determines the IP address of the first user TER1 and informs this user of the call by the third user TER3. If the first user TER1 wishes to accept the call, he communicates his consent to this call to the control device SSW. The control device SSW then sends the address (IP address and UDP address) of the network node MG and the addresses of both the network node MG and the third user TER3 to the border gateway BG, and the address of the border gateway BG to the third user TER3. With this address information, data packets of the communication session can be sent from the first user TER1, via the network node MG and the border gateway BG, to the third user TER3, and vice versa, from the latter, via the border gateway BG and the network node MG, to the first user TER1.

If the communication session is terminated, for example, on the initiation of the first user TER1, the border gateway BG is informed of this, as is the network node MG. The border gateway BG then ceases to accept any further data sent by the third user TER3. The border gateway BG prevents unwanted data from reaching any user or any network device of the multimedia network MN. It is consequently impossible, for example, for a data attack to be conducted from outside the multimedia network MN for the purpose of blocking the multimedia network MN or devices of this network. The only device which could be blocked is the border gateway BG. Blocking of this gateway, however, does not result in any impairment within the multimedia network MN.

Several multimedia networks MN can also be coupled to one another, in a manner analogous to the case of the coupling of the (closed) multimedia network MN according to the invention to the (open) internet. In this case, each of these networks has its own control device. Since a called user of an external network is not known in the network of the calling user, the control device of the calling network relays the call number of the called user to the control device of the external network. Both control devices then inform one another of the IP addresses of their respective border gateways via which the communication is to be routed.

In a further embodiment, the payload data is transmitted in encrypted form between the border gateways (BG) of a first and second multimedia network respectively. This is particularly advantageous if these multimedia networks MN are operated by two mutually cooperating network operators or if these multimedia networks represent two spatially separate sub-networks of a network operator which are interconnected via external lines, an external network or the internet. In addition, or alternatively, the payload data can be compressed. For this purpose, a transmitting network node MG at the border of a first sub-network compresses/and or encrypts all data to be transmitted to a receiving border gateway BG of a second sub-network. The receiving network node then performs a corresponding decryption and/or decompression. Compression permits, for example, optimum utilization of the transmission capacities that exist on a long transmission link.

It is also possible to connect the multimedia network MN according to the invention to a line-conducted telephone network. For this purpose, a protocol conversion is performed in a defined network node, for example, in a border gateway BG of the telephone network. A protocol conversion is necessary, for example at transitions from the fixed network to a mobile telephony network, since the so-called codecs used in the mobile telephony network are unknown in the fixed network. The payload data of the received IP data packets is then appropriately recoded and a determined communication channel is established between this border gateway and the corresponding user of the telephone network on which the recoded data is transmitted. The establishment of this communication channel is initiated by a control device, of the line-conducted telephone network, which is connected to the control device SSW of the multimedia network MN.

It is also possible to create closed access networks to a multimedia network MN. The same described data stream routing mechanisms are then effected in both networks. Frequently, this will result in fixed assignments between the border gateway BG of an access network and border gateway, provided for this access network, of the multimedia network. Due to the fixed assignment, only a reduced addressing is required between these gateways; in particular, there is no need for the mutual communication of the IP addresses. In this case, a so-called protocol header compression is effected advantageously for the data transmitted between these gateways.

In access networks to a multimedia network MN, it must be ensured that the bandwidth granted to the users is not exceeded. The access network monitors compliance with agreed or defined bandwidths. If the bandwidth is exceeded, the network can react in different ways. Thus, for example, there can be a reduction of the priority for packets in the exceeded bandwidth. Conventional IP networks handle a mixture of both so-called TCP/IP data, i.e., data which occurs sporadically and which is to be assigned to a data stream for a short period only (e.g. a HTTP data stream between an internet server and an internet terminal), and stream-oriented real-time data or data streams. It is only this real-time data which requires privileged handling (e.g. in respect of real-time requirements) and must therefore be monitored in respect of its bandwidth. The rest of the data is handled, insofar as resources are available, according to the so-called “best-effort” mode, i.e., as well as possible. A consequence of the mixing of all of this data is that a network node used for bandwidth monitoring, for example, an access node or network access server (NAS), must first distinguish “non-privileged” data from privileged data and, from this privileged data, identify multimedia data streams and assign them to individual data relationships. Only then can the data of a data relationship be monitored. In order to identify these multimedia data streams, it may be necessary to evaluate information from different protocol layers, resulting in a high resource requirement for the IP router.

According to the invention, multimedia data is separated from other data at an early stage, in an access device of the access network. The network node MG then receives exclusively multimedia data streams, which are of the same type and are to be handled in the same way, concerning which it is already informed by the control device SSW. This early separation of data which is to be privileged and other data enables the resource requirement for the handling of the other data to be kept small (so-called hop-by-hop monitoring of bandwidths). The resource requirement for bandwidth monitoring in the network node MG is also kept small, since there is no need for resource-consuming distinction of different types of data and assignment to individual multimedia data streams.

The border gateway of the access network can additionally comprise a connection to the (open) internet. A user of the access network can then choose whether he wishes a connection to the corresponding multimedia network MN or to the internet, these being distinguished on the basis of, for example, the destination address.

The multimedia networks closed by means of the network nodes or border gateways each have their own IP address range. IP addresses are only valid in the respectively closed network. Consequently, the entire IP address space, for example, 32 bits for version 4 of the internet protocol, can be used in each network. Whereas this address space is easily sufficient for a closed network, IP addresses worldwide are becoming concise. For version 6 of the internet protocol, therefore, future open networks or sub-networks must be realized with a markedly expanded address space, whereas there is no such necessity for the multimedia networks considered here.

1. Method for routing data streams or a sequence of data packets between users of a connectionless packet data network with the following steps:
a signalling is performed, between a calling user, a control device and a called user, in the course of which the calling user sends to the control device a request for a communication session with the called user and this control device ascertains a network address of the called user,
the control device defines one or more network nodes via which the data packets to be sent in connection with the communication session between the users, in a respectively determined sequence for each transmission direction, are to be routed, and
the control device sends to the users and to the defined network node(s) participating in the communication session address information respectively required for relaying or forwarding the data packets in the defined sequence.

2. Method according to claim 1, wherein, when the control device identifies the end of the communication session, this control device sends a corresponding message to the participating network nodes, by which these network nodes are requested not to forward any further data packets of this communication relationship.

3. Method according to claim 1, wherein, for the purpose of call signalling, the calling user relays a unique call number or a unique name of the called user.

4. Method according to claim 1, wherein, for legally permitted communication monitoring, the data streams of defined communication relationships are examined or copied, the control device instructing corresponding network nodes to copy defined data streams at defined times and/or to send them to defined devices.

5. Method according to claim 1, wherein the network nodes send defined communication data to a charge logging device which compiles a charge account for the users.

6. Method according to claim 1, wherein a transmission protocol, differing from the rest of the transmission path, for transmitting the data content of the data packets is executed between two network nodes or a network node and a user.

7. Method according to claim 1, wherein payload data and/or the protocol data is converted, for example, compressed, in a transmitting network node and converted back again, for example, correspondingly decompressed, in a receiving network node.

8. Packet data network with a control device and a mediating network node, with the following means for routing data streams between users of this packet data network:
call signalling means for performing a call signalling, the calling user sending to the control device a request for a communication session with the called user and this control device ascertaining a network address of the called user,
definition means for defining one or more network nodes and for defining the respective sequence of these network nodes for relaying the data packets of a transmission device, and
relay means for sending the necessary address information to the respectively participating users and to the defined network node(s) for the purpose of forwarding the data packets in the defined sequence.

9. Control device with signalling interfaces to the users of a communication session and to one or more network nodes, with the following means for establishing and monitoring connections:
transmission and receiving means for performing a call signalling between the calling user and the called user,
search means for ascertaining a network address of the called user,
definition means for defining one or more network nodes and for defining the respective sequence of these network nodes for relaying the data packets of a transmission device, and
relay means for sending the necessary address information to the respectively participating users and to the defined network node(s) for the purpose of forwarding the data packets in the defined sequence.

10. Program module for execution in a control device with control means for controlling the following steps:
performance of a call signalling between the calling user and the called user
ascertainment of a network address of the called user
definition of one or more network nodes and definition of the respective sequence of these network nodes for relaying the data packets of a transmission device, and
sending of the necessary address information to the respectively participating users and to the defined network node(s) for the purpose of forwarding the data packets in the defined sequence.
